(19) United States
(12) Patent Application Publication
(10) Pub. No.: US 2025/0061724 A1
(43) Pub. Date: Feb. 20, 2025

(54) TARGET CALCULATION METHOD AND COMPUTING DEVICE

(71) Applicant: HITACHI ASTEMO, LTD., Hitachinaka-shi, Ibaraki (JP)

(72) Inventors: Shigenori HAYASE, Tokyo (JP); Hitoshi HAYAKAWA, Hitachinaka-shi (JP)

(73) Assignee: HITACHI ASTEMO, LTD., Hitachinaka-shi, Ibaraki (JP)

(21) Appl. No.: 18/723,730

(22) PCT Filed: Aug. 24, 2022
(86) PCT No.: PCT/JP2022/031949

§ 371 Date: Jun. 24, 2024

(30) Foreign Application Priority Data
Feb. 15, 2022 (JP) 2022-021389

(51) Int. Cl. G06V 20/56; G06T 7/70

(52) U.S. Cl. CPC G06V 20/56; G06T 7/70

(57) ABSTRACT

A target calculation method is a target calculation method executed by a computing device including an acquisition unit that acquires a sensor output that is an output of a sensor that acquires information on a surrounding environment, target calculation method including: detection processing of detecting a target by a plurality of techniques using the sensor output and detecting a target state including at least a position and a type of the target; same target determination processing of determining a same target from a plurality of the targets detected by each of the plurality of techniques in the detection processing; and merging processing of merging the target states of the target determined to be the same target in the same target determination processing and outputting the merged target states as a merged target.

### TECHNICAL FIELD

The present invention relates to a target calculation method and a computing device.

### BACKGROUND ART

To achieve the advanced autonomous driving of a vehicle, a technique using machine learning has been studied. PTL 1 discloses a method for improving detection capabilities of a detection algorithm of a driving assistance system, the method comprising the steps of: providing a vehicle-based driving assistance system comprising a processing entity implementing a detection algorithm for providing detection results, the driving assistance system comprising at least one sensor for detecting static environment features in the surrounding of the vehicle; receiving sensor information regarding a static environment feature from the sensor at a processing entity of the vehicle; processing said received sensor information, thereby obtaining processed sensor information; receiving at least one stored static environment feature from an environment data source; comparing processed sensor information with said stored static environment feature; determining if an inconsistency between processed sensor information and a stored static environment feature exists; and if an inconsistency between processed sensor information and a stored static environment feature is determined, modifying the detection algorithm based on a machine-learning algorithm by providing training information derived from the comparison result of processed sensor information with said stored static environment feature to said machine-learning algorithm.

### CITATION LIST

### Patent Literature

PTL 1: JP 2021-18823 A

### SUMMARY OF INVENTION

### Technical Problem

In the invention described in PTL 1, a recognition error may occur.

### Solution to Problem

A target calculation method according to a first aspect of the present invention is a target calculation method executed by a computing device including an acquisition unit that acquires a sensor output that is an output of a sensor that acquires information on a surrounding environment, the target calculation method including: detection processing of detecting a target by a plurality of techniques using the sensor output and detecting a target state including at least a position and a type of the target; same target determination processing of determining a same target from a plurality of the targets detected by each of the plurality of techniques in the detection processing; and merging processing of merging the target states of the target determined to be the same target in the same target determination processing and outputting the merged target states as a merged target.

A computing device according to a second aspect of the present invention includes: an acquisition unit configured to acquire a sensor output that is an output of a sensor that acquires information on a surrounding environment; a detection unit configured to detect a target by a plurality of techniques using the sensor output and detect a target state including at least a position and a type of the target; a same target determination unit configured to determine a same target from a plurality of the targets detected by each of the plurality of techniques in the detection unit; and a merging unit configured to merge the target states of the target determined to be a same target by the same target determination unit and output the merged target states as a merged target.

### Advantageous Effects of Invention

According to the present invention, since a target is detected using a plurality of techniques, recognition errors can be reduced.

### BRIEF DESCRIPTION OF DRAWINGS

FIG. 1 is a functional configuration diagram of a computing device according to a first embodiment.

FIG. 2 is a diagram showing an example of the processing of a same target determination unit.

FIG. 3 is a hardware configuration diagram of the computing device.

FIG. 4 is a flowchart showing the processing of the computing device.

FIG. 5 is a diagram showing a first operation example.

FIG. 6 is a diagram showing a second operation example.

FIG. 7 is a diagram showing a third operation example.

FIG. 8 is a functional configuration diagram of the computing device in the second modification.

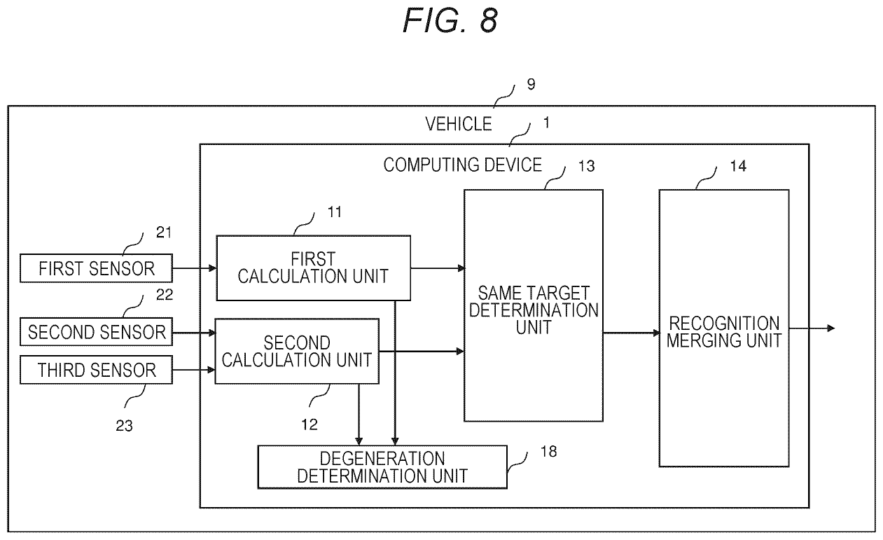

FIG. 9 is a functional configuration diagram of a computing device according to a second embodiment.

FIG. 10 is a diagram showing an example of the ratio information.

### DESCRIPTION OF EMBODIMENTS

### First Embodiment

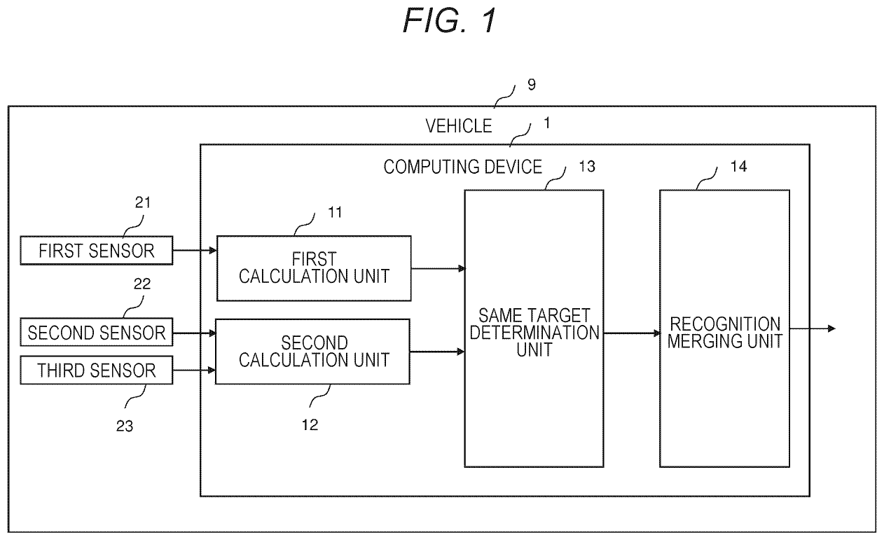

Hereinafter, a first embodiment of a computing device and a target calculation method will be described with reference to FIGS. 1 to 7.

### (Configuration)

FIG. 1 is a functional configuration diagram of a computing device 1. The computing device 1 is mounted on the vehicle 9 together with the first sensor 21, the second sensor 22, and the third sensor 23. The computing device 1 includes a first calculation unit 11, a second calculation unit 12, a same target determination unit 13, and a recognition merging unit 14.

Each of the first sensor 21, the second sensor 22, and the third sensor 23 is a sensor that acquires information on the surrounding environment of the vehicle 9. The first sensor 21, the second sensor 22, and the third sensor 23 output information obtained by sensing to the computing device 1 as a sensor output. Specific configurations of the first sensor 21, the second sensor 22, and the third sensor 23 are not limited, and are, for example, a camera, a laser range finder, a light detection and ranging (LiDAR), and the like. However, any one of the first sensor 21, the second sensor 22, and the third sensor 23 may be the same type of sensor.

The first calculation unit 11 and the second calculation unit 12 calculate the target state based on the sensor output. In the present embodiment, the target state is a position and a type of the target. However, the target state may include the speed of the target. For example, the position of the target is calculated as coordinates in an orthogonal coordinate system in which the center of the vehicle 9 is an origin, the front side of the vehicle 9 is a plus side of the X axis, and the right-hand side of the vehicle 9 is a plus side of the Y axis. The type of target is an automobile, a two-wheeled vehicle, a pedestrian, a traveling lane, a stop line, a traffic light, a guardrail, a building, and the like. The sensor output of the first sensor 21 is input to the first calculation unit 11, and the sensor outputs of the second sensor 22 and the third sensor 23 are input to the second calculation unit 12. However, sensor outputs of the same sensor may be input to the first calculation unit 11 and the second calculation unit 12.

The first calculation unit 11 and the second calculation unit 12 operate independently and calculate a target state, that is, a position and a type of the target. The first calculation unit 11 and the second calculation unit 12 calculate a target state at short time intervals, for example, every 10 ms, attach an identifier, that is, an ID, to the target state, and output the target state to the same target determination unit 13.

The first calculation unit 11 detects a target based on rules. The first calculation unit 11 includes information on rules such as a predetermined computing equation. The first calculation unit 11 obtains the target state, that is, the position and the type of the target by processing the sensor output according to this rule. Hereinafter, the target calculated by the first calculation unit 11 is referred to as a “rule target”. In addition, the calculation of the target by the first calculation unit 11 is also referred to as “rule-based detection processing”.

The second calculation unit 12 detects a target based on machine learning. The second calculation unit 12 processes the sensor output using the parameter generated by the training program using a large number of pieces of training data and the inference program to obtain the target state. It can also be said that the processing of the second calculation unit 12 is to perform inference on an unknown phenomenon by an inductive approach using existing data. Hereinafter, the target calculated by the second calculation unit 12 is referred to as an “AI target”. In addition, the calculation of the target by the second calculation unit 12 is also referred to as “AI detection processing”.

The same target determination unit 13 simply determines the sameness between the rule target calculated by the first calculation unit 11 and the AI target calculated by the second calculation unit 12. Specifically, the same target determination unit 13 associates each AI target with a rule target existing at a predetermined distance or less from and closest to the corresponding AI target. The same target determination unit 13 performs only processing based on the AI target and does not perform processing based on the rule target. The recognition merging unit 14 merges the rule target and the AI target using the determination result of the same target determination unit 13 to output the merged result. Hereinafter, the target output by the recognition merging unit 14 is referred to as a “merged target”. In the present embodiment, a rule target is used to determine the presence or absence of the target and the position of the target, and an AI target is used to determine the type of the target. The target state output by the recognition merging unit 14 is used by another device mounted on the vehicle 9, for example, to implement autonomous driving or an advanced driving support system.

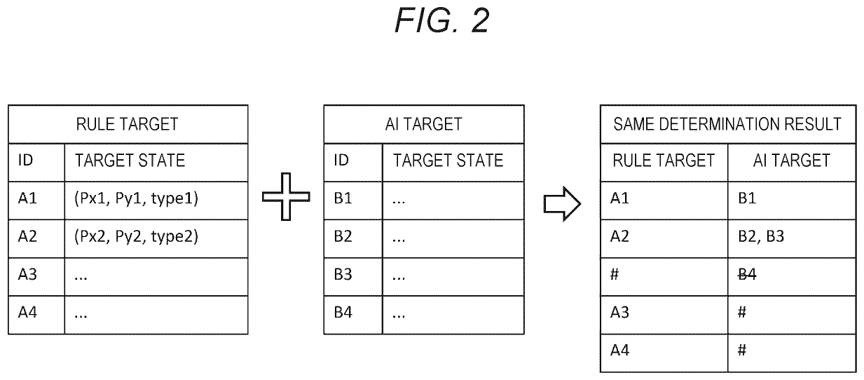

FIG. 2 is a diagram showing an example of the processing of the same target determination unit 13. When the four rule targets and the four AI targets shown in FIG. 2 are calculated, the same target determination unit 13 performs association in the same determination result as illustrated on the right side. In FIG. 2, “#” indicates that there is no associated target. In the example shown in FIG. 2, the rule target that is at a predetermined distance or less from AI target B1 and is closest to AI target B1 is A1. In addition, the rule target that is at a predetermined distance or less from AI targets B2 and B3 and is closest to AI targets B2 and B3 is A2. Furthermore, it is indicated that there is no rule target at a predetermined distance or less from the AI target B4. The reason why the strikethrough is attached to the AI target B4 will be described below.

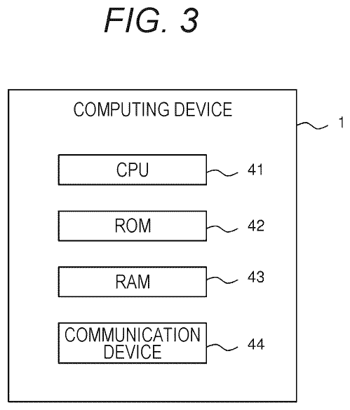

FIG. 3 is a hardware configuration diagram of the computing device 1. The computing device 1 includes a CPU 41 that is a central processing unit, a ROM 42 that is a read-only storage device, a RAM 43 that is a readable/writable storage device, and a communication device 44. The CPU 41 develops the program stored in the ROM 42 in the RAM 43 and executes the program to perform the above-described various operations.

The computing device 1 may be implemented by a field programmable gate array (FPGA) which is a rewritable logic circuit or an application-specific integrated circuit (ASIC) which is an application-specific integrated circuit instead of the combination of the CPU 41, the ROM 42, and the RAM 43. In addition, the computing device 1 may be implemented by a combination of different configurations, for example, a combination of the CPU 41, the ROM 42, the RAM 43, and the FPGA instead of the combination of the CPU 41, the ROM 42, and the RAM 43. The communication device 44 is, for example, a communication interface supporting IEEE802.3, and transmits and receives information between another device mounted on the vehicle 9 and the computing device 1. Since the communication device 44 acquires the sensor output from the sensor mounted on the vehicle 9, the communication device can also be referred to as an “acquisition unit”.

### (Operation)

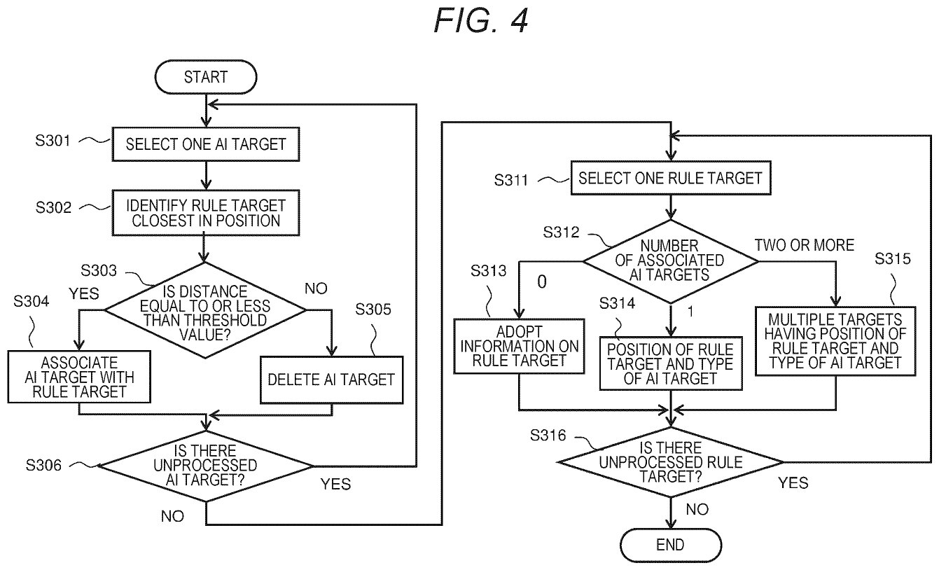

FIG. 4 is a flowchart showing the processing of the computing device 1. However, the detection of the target by the first calculation unit 11 and the second calculation unit 12 is completed before the processing shown in FIG. 4 is started. In FIG. 4, first, in step S301, the same target determination unit 13 selects one AI target. In subsequent step S302, the same target determination unit 13 identifies a rule target closest in position to the AI target selected in step S301.

In subsequent step S303, the same target determination unit 13 determines whether the distance between the AI target selected in step S301 and the rule target identified in step S302 is equal to or less than a predetermined threshold value. If determining that the distance between the two is equal to or less than the predetermined threshold value, the same target determination unit 13 proceeds to step S304, and the AI target and the rule target are associated with each other. It should be noted that as shown in the example in FIG. 2, one rule target may be associated with a plurality of AI targets.

If determining that the distance between the two is longer than the predetermined threshold value, the same target determination unit 13 proceeds to step S305 and deletes the AI target selected in step S301. The deletion processing corresponds to, for example, that the AI target B4 is displayed by strikethrough in the example shown in FIG. 2. It should be noted that if the rule target is not detected, it is negatively determined in step S303 that the distance between the AI target and the rule target is infinite.

In step S306 executed after step S304 or step S305, the same target determination unit 13 determines whether there is an unprocessed AI target. The same target determination unit 13 returns to step S301 if determining that there is an unprocessed AI target, and proceeds to step S311 if determining that there is no unprocessed AI target. In step S311, the recognition merging unit 14 selects one unselected rule target. In subsequent step S312, the recognition merging unit 14 determines the number of AI targets associated with the rule target selected in step S311.

If determining that the number of associated rule targets is “0”, that is, there are no associated rule targets, the recognition merging unit 14 adopts the position information and the type information of the rule target. For example, the rule targets A3 and A4 in the example shown in FIG. 2 correspond to this example. If determining that the number of associated rule targets is “1”, the recognition merging unit 14 sets a target obtained by combining the position of the rule target and the type of the AI target. For example, the rule target A1 in the example shown in FIG. 2 corresponds to this example.

If determining that the number of associated rule targets is “2 or more”, the recognition merging unit 14 sets a plurality of targets obtained by combining the positions of the rule targets and the types of the respective AI targets. For example, the rule target A2 in the example shown in FIG. 2 corresponds to this example. In step S316 executed if any one of steps S313 to S315 is completed, the recognition merging unit 14 determines whether there is an unprocessed rule target, that is, a rule target not selected in step S311. If determining that there is an unprocessed rule target, the recognition merging unit 14 returns to step S311, and if determining that there is no unprocessed rule target, the recognition merging unit ends the processing shown in FIG. 4.

### (Operation Example)

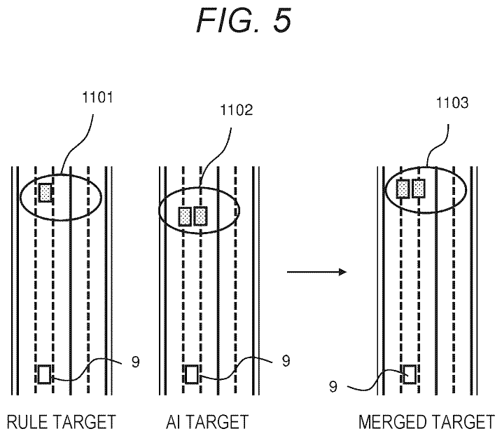

Hereinafter, three operation examples will be described with reference to FIGS. 5 to 7. In each operation example, in order to describe the relationship among the rule target, the AI target, and the merged target, a schematic diagram in which only each target is described is shown.

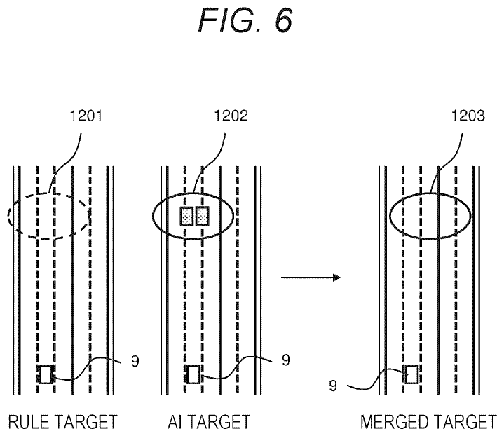

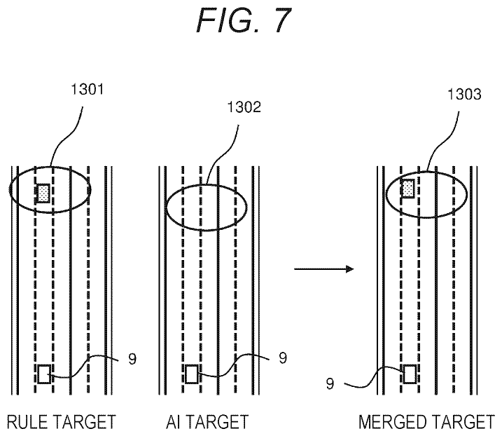

FIG. 5 is a diagram showing a first operation example. In the three diagrams shown in FIG. 5, the rule target, the AI target, and the merged target are shown in order from the left. In each diagram, a hollow quadrangle shown in the lower part is a vehicle 9, and a hatched quadrangle shown in the upper part is a detected target. The same applies to FIGS. 6 and 7 described below. The first calculation unit 11 detects one target A1 far from the vehicle 9 as indicated by reference numeral 1101. The second calculation unit 12 detects two targets B1 and B2 far from the vehicle 9 as indicated by reference numeral 1102. In the present example, the distance between the AI target B1 and the rule target A1 is equal to or less than a predetermined threshold value, and the distance between the AI target B2 and the rule target A1 is equal to or less than a predetermined threshold value.

In this case, processing is performed as follows in the flowchart in FIG. 4. That is, for both AI targets B1 and B2, positive determination is made in step S303 in FIG. 4, and they are associated with rule target A1 in step S304. Then, since two AI targets are associated with the rule target A1 in step S312, the process proceeds to step S315, and two merged targets having the position of the rule target A1 are output as indicated by reference numeral 1103.

FIG. 6 is a diagram showing a second operation example. The first calculation unit 11 does not detect any target as indicated by reference numeral 1201. The second calculation unit 12 detects two targets B3 and B4 far from the vehicle 9 as indicated by reference numeral 1202. In this case, processing is performed as follows in the flowchart in FIG. 4. That is, even when any one of targets B3 and B4 is selected in step S301, the distance to the rule target that does not exist is set to be infinite, and a negative determination is made in step S303. Therefore, in step S305, the targets B3 and B4 are deleted. In the present example, since there is no rule target, the processing of steps S311 to S316 is not performed, and as a result, as indicated by reference numeral S1203, the recognition merging unit 14 does not output a merged target.

FIG. 7 is a diagram showing a third operation example. The first calculation unit 11 detects one rule target A2 as indicated by reference numeral 1301. The second calculation unit 12 does not detect any target as indicated by reference numeral 1302. In this case, processing is performed as follows in the flowchart in FIG. 4. That is, since the AI target is not detected, the processing of steps S301 to S305 is not performed, the negative determination is made in step S306, and the process proceeds to step S311. In step S311, the target A2 is selected, and in subsequent step S312, since there is no related AI target, the recognition merging unit 14 proceeds to step S313. In step S313, the information on the rule target A2 is adopted as the merged target as it is.

According to the above-described first embodiment, the following action and effect can be obtained.

(1) The communication device 44 that acquires a sensor output which is an output of a sensor that acquires information on the surrounding environment executes the following target calculation method. A target calculation method includes: detection processing of detecting a target by a plurality of techniques using sensor outputs, executed by the first calculation unit 11 and the second calculation unit 12, and detecting a target state including at least a position and a type of the target; same target determination processing of determining a same target from a plurality of targets detected by a plurality of respective techniques in the detection processing, executed by the same target determination unit 13; and merging processing of merging target states of targets determined to be the same target in the same target determination processing, executed by the recognition merging unit 14, and outputting the merged target states as a merged target. Therefore, in the target calculation technique executed by the computing device 1, since the target is detected using a plurality of techniques, recognition errors can be reduced.

(2) The detection processing executed by the computing device 1 includes: rule-based detection processing that is executed by the first calculation unit 11 and detects a rule target that is a target based on rules using a sensor output; and AI detection processing that is executed by the second calculation unit 12 and detects an AI target that is a target based on machine learning using a sensor output. Therefore, the target can be detected based on two techniques of rule-based detection and machine learning having different properties.

(3) In the same target determination processing, as shown in steps S302 to S304 in FIG. 4, rule targets at a distance of a predetermined distance or less from the AI target are determined as the same targets, and association is performed. In the merging processing, the generation of a merged target based on the AI target determined by the same target determination unit 13 that the rule target is not present at the predetermined distance or less is not performed. Therefore, a target detected only in the AI detection processing, which tends to have excessive detection of erroneously detecting a non-existing target, can be determined as erroneously detected and the output can be suppressed.

(4) In the merging processing, as shown in steps S312 to S315 in FIG. 4, for a rule target having one or more associated AI targets, a target state calculated based on the target state of the AI target and the target state of the rule target is output as a merged target, and for a rule target having no associated AI target, the rule target is output as a merged target. Therefore, the AI target and the rule target which are associated with each other output a merged target using information on the two, and the rule target that is detected by rule-based detection in which excessive detection is less likely to occur and has no associated AI target outputs information on the rule target as it is as a merged target, so that it is possible to detect a target with high accuracy and without leakage.

(5) In the merging processing, as shown in step S314 in FIG. 4, a rule target having only one associated AI target is output as a merged target obtained by combining the type of AI target and the position of the rule target. As shown in step S315 in FIG. 4, the rule target having two or more associated AI targets is output as a plurality of merged targets obtained by combining the position of the rule target and the types of the respective AI targets. As shown in step S313 in FIG. 4, for a rule target having no associated AI target, the rule target is output as a merged target. In general, it is not easy to correctly determine two vehicles traveling in close proximity to each other at the same speed as two vehicles by rule-based detection. In the present embodiment, by adopting the result of the AI detection processing in such a case, the detection accuracy of the target can be improved.

### (First Modification)

In steps S314 and S315 in FIG. 4, instead of adopting the position information on the rule target as it is, a weighted average value of the information on the rule target and the information on the AI target may be adopted. However, in this case, a predetermined coefficient is set such that the weight of the information on the rule target is higher than the weight of the information on the AI target. In other words, the position of the merged target in this case has a position closer to the position of the rule target than the position of the AI target.

In addition, when the target state includes speed information, only the information on the rule target may be adopted as in the position information in the first embodiment, or a weighted average value of the information on the rule target and the information on the AI target may be adopted. However, also in this case, a predetermined coefficient is set such that the weight of the information on the rule target is higher than the weight of the information on the AI target. In other words, the position of each merged target in this case has a position closer to the position of the rule target than the position of the corresponding AI target.

(6) In the merging processing, for a rule target having only one associated AI target, a merged target having a position closer to the position of the rule target than the position of the AI target is output, for a rule target having two or more associated AI targets, a plurality of merged targets having positions closer to the position of the rule target than the positions of the AI targets are output, and for a rule target having no associated AI target, the rule target is output as a merged target.

### (Second Modification)

FIG. 7 is a functional configuration diagram of the computing device 1 in the second modification. The computing device 1 shown in FIG. 7 further includes a degeneration determination unit 18 in addition to the configuration of the computing device 1 in the first embodiment. When the rule target output by the first calculation unit 11 and the AI target output by the second calculation unit 12 are greatly different, the degeneration determination unit 18 outputs a command of the degeneration operation to the vehicle 9. For example, when the distance between any rule target and the AI target is a predetermined distance or more, or when the number of rule targets and the number of AI targets have a difference of a predetermined ratio or more, the degeneration determination unit 18 determines that the rule target and the AI target are greatly different from each other. The command of the degeneration operation is a command to limit the function of the vehicle 9. For example, when the vehicle 9 is provided with an autonomous driving system, the command of the degeneration operation is a switch command to manual driving or a stop command of the vehicle 9, to the autonomous driving system.

### (Third Modification)

The computing device 1 may include three or more target state detection units. Each target state calculation unit is classified into any one of a rule detection unit and an AI detection unit according to an operation principle, a target calculated by the target state calculation unit classified into the rule detection unit is a rule target, and a target calculated by the target state calculation unit classified into the AI detection unit is an AI target. The processing of the same target determination unit 13 and the recognition merging unit 14 is similar to that of the first embodiment.

### (Fourth Modification)

The recognition merging unit 14 may further determine which merged target calculated in the past each of the calculated merged targets matches with. For this determination, for example, the position, speed, and type of the merged target can be used. It is desirable that the recognition merging unit 14 assign an ID for identifying each merged target, and assign the same ID to the same merged target at different times.

### Second Embodiment

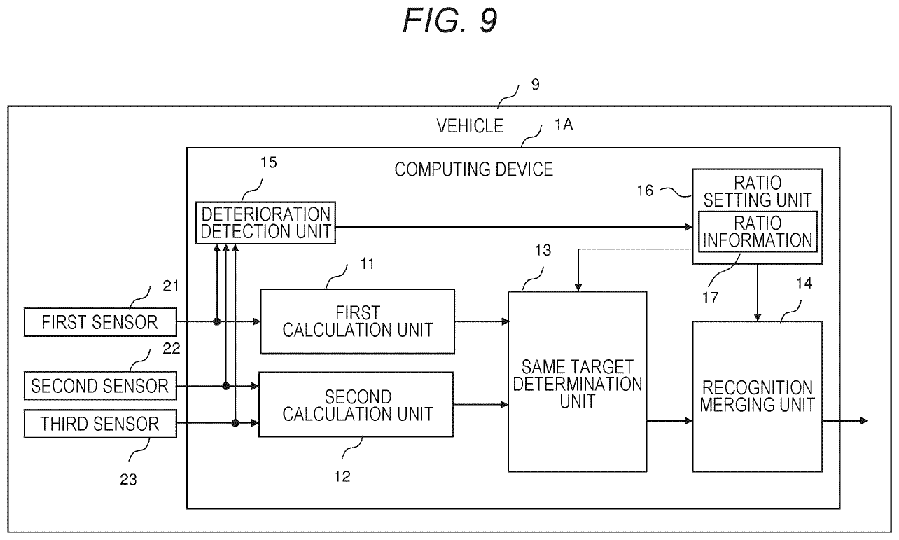

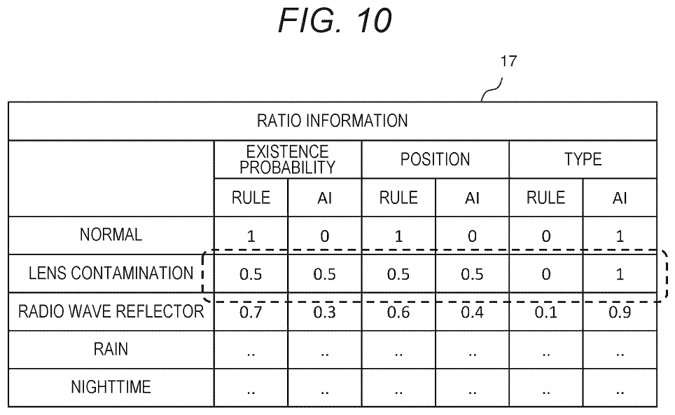

A second embodiment of a computing device and a target calculation method will be described with reference to FIGS. 9 and 10. In the following description, the same components as those in the first embodiment are denoted by the same reference numerals, and differences will be mainly described. The points not particularly described are the same as those in the first embodiment. The present embodiment is different from the first embodiment mainly in that the ratio between the AI target and the rule target in the merged target is changed according to the situation.

FIG. 9 is a functional configuration diagram of the computing device 1A in the second embodiment. The computing device 1A shown in FIG. 9 further includes a deterioration detection unit 15 and a ratio setting unit 16 in addition to the configuration of the computing device 1 in the first embodiment. In addition, the first calculation unit 11 and the second calculation unit 12 output numerical values indicating a degree of certainty of the detected target state together. The numerical value indicating the degree of certainty is, for example, a value of 0 to 1, and indicates that the larger the value, the more certain. The deterioration detection unit 15 detects deterioration of the sensor output and outputs the type of deterioration to the ratio setting unit 16. However, when not detecting the deterioration of the sensor output, the deterioration detection unit 15 outputs information to the effect that there is no deterioration to the ratio setting unit 16.

The deterioration of the sensor output detected by the deterioration detection unit 15 includes deterioration of the output caused by some cause of the sensor and deterioration of the output caused by the surrounding environment. The deterioration of the output caused by the sensor is, for example, the adhesion of dirt to a lens or an imaging element when the sensor is a camera. The deterioration of the output caused by the surrounding environment is, for example, backlight, rainfall, dust, and nighttime when the sensor is a camera, and, for example, the presence of radio wave reflectors when the sensor is a radar. The deterioration detection unit 15 may detect deterioration of the sensor output using the sensor output, or may acquire information from the outside by communication to estimate deterioration of the sensor output.

The ratio setting unit 16 sets the ratio between the rule target and the AI target in the merging processing to the same target determination unit 13 and the recognition merging unit 14 according to the type of deterioration of the sensor output. In the present embodiment, the computing device 1A stores the ratio information 17 in the ROM 42 which is a storage unit. The ratio information 17 stores information on the ratio between the rule target and the AI target in determining the existence probability of the target, the position of the target, and the type of the target in the merging processing for each type of deterioration of the sensor output.

FIG. 10 is a diagram showing an example of the ratio information 17. In the example shown in FIG. 10, the ratio of the rule target and the AI target in determining the existence probability of a target, the position of the target, and the type of the target is described for each of “normal” without deterioration in sensor output, lens contamination, radio wave reflectors, rain, and nighttime. For example, when the deterioration detection unit 15 notifies lens contamination, the ratio setting unit 16 outputs information on six numerical values surrounded by a broken line in FIG. 10 to the same target determination unit 13 and the recognition merging unit 14.

Differences in processing in the same target determination unit 13 and the recognition merging unit 14 from the first embodiment will be described. It should be noted that the processing of the same target determination unit 13 and the recognition merging unit 14 when the ratio information 17 outputs a numerical value of “normal” is the same as that in the first embodiment. The same target determination unit 13 determines the presence of the target at each position according to the ratio of the existence probability in step S304 in FIG. 4. For example, when the rule target A9 is present at a predetermined distance or less from a certain AI target B9, the same target determination unit 13 determines whether to associate the two as follows. That is, when the sum of the product of the degree of certainty of the AI target B9 calculated by the second calculation unit 12 and the value of the coefficient of the existence probability of the AI target in the ratio information 17 and the product of the degree of certainty of the rule target A9 calculated by the first calculation unit 11 and the value of the coefficient of the existence probability of the rule target in the ratio information 17 exceeds a predetermined threshold value, for example, “1.0”, the same target determination unit 13 associates the two.

The recognition merging unit 14 changes the processing of steps S314 and S315 in FIG. 4 as follows. That is, the recognition merging unit 14 calculates the position of the merged target by the weighted average of the position of the rule target and the position of the AI target, and uses the value of the ratio information 17 output by the ratio setting unit 16 for a coefficient of the weighted average. In addition, the recognition merging unit 14 adopts, as the type of the merged target, the type of the target that is larger one of a value obtained by multiplying the degree of certainty of the rule target by the coefficient of the type of the rule target in the ratio information 17 and a value obtained by multiplying the degree of certainty of the AI target by the coefficient of the type of the AI target in the ratio information 17.

According to the above-described second embodiment, the following action and effect can be obtained.

(7) The computing device 1A includes deterioration detection processing of detecting deterioration of the sensor output. In the merging processing, when the deterioration of the sensor output is detected by the deterioration detection processing, the AI target and the rule target are merged at a predetermined ratio to generate a merged target. Therefore, the computing device 1A can generate a merged target in which the information on the rule target and the information on the AI target are merged.

(8) The computing device 1A includes a ROM42 that stores ratio information 17 that defines the ratios of the AI target and the rule target for each type of deterioration of the sensor output. The merging processing identifies the type of deterioration of the sensor output and identifies the ratios of the AI target and the rule target with reference to the ratio information 17. Therefore, the computing device 1A can generate a merged target in which the information on the rule target and the information on the AI target are merged with optimal weighting according to the situation. In particular, in the case of the deterioration state of the sensor output included in the training data used when the parameter used by the second calculation unit 12 is generated, since the reliability of the AI detection processing is relatively high, a high ratio can be set in the ratio information 17, and the recognition accuracy can be improved.

### (Modification of Second Embodiment)

The deterioration of the sensor output may be applied to each part of the sensor output. For example, when the sensor is a camera, the deterioration detection unit 15 divides a photographed image obtained by photographing by the camera into a plurality of regions, determines output deterioration for each of the regions, and sets the type of deterioration for each of the regions as the ratio setting unit 16. The ratio setting unit 16 determines the ratio between the AI target and the rule target based on the ratio information 17 for each region of the sensor output, and the same target determination unit 13 and the recognition merging unit 14 merge the AI target and the rule target at the ratio specified by the ratio setting unit 16 for each region of the sensor output to generate a merged target.

In the above-described embodiments and modifications, the configuration of the functional block is merely an example. Some functional configurations shown as separate functional blocks may be integrally configured, or a configuration represented in one functional block diagram may be divided into two or more functions. In addition, some of the functions of each functional block may be included in another functional block.

In each of the above-described embodiments and modifications, the program is stored in the ROM 42, but the program may be stored in a non-volatile storage device (not shown). In addition, the computing device 1 may include an input/output interface (not shown), and a program may be read from another device through a medium that can be used by the input/output interface and the computing device 1 when necessary. Here, the medium refers to, for example, a storage medium attachable and detachable to and from the input/output interface, a communication medium, that is, a network such as wired, wireless, or optical, or a carrier wave or a digital signal propagating through the network. In addition, some or all of the functions implemented by the program may be implemented by a hardware circuit or an FPGA.

Each of the above-described embodiments and modifications may be combined with each other. Although various embodiments and modifications have been described above, the present invention is not limited to these contents. Other aspects conceivable within the scope of the technical idea of the present invention are also included in the scope of the present invention.

### REFERENCE SIGNS LIST

1, 1A computing device
11 first calculation unit
12 second calculation unit
13 same target determination unit
14 recognition merging unit
15 deterioration detection unit
16 ratio setting unit
17 ratio information
18 degeneration determination unit
44 communication device

1. A target calculation method executed by a computing device including an acquisition unit that acquires a sensor output that is an output of a sensor that acquires information on a surrounding environment, the target calculation method comprising:
detection processing of detecting a target by a plurality of techniques using the sensor output and detecting a target state including at least a position and a type of the target;
same target determination processing of determining a same target from a plurality of the targets detected by each of the plurality of techniques in the detection processing; and
merging processing of merging the target states of the target determined to be the same target in the same target determination processing and outputting the merged target states as a merged target.

2. The target calculation method according to claim 1, wherein the detection processing includes:
rule-based detection processing of detecting a rule target that is a target based on rules using the sensor output; and
AI detection processing of detecting an AI target that is a target based on machine learning using the sensor output.

3. The target calculation method according to claim 2, wherein
in the same target determination processing, the rule target at a distance of a predetermined distance or less from the AI target is determined as a same target and associated, and
in the merging processing, generation of the merged target based on the AI target for which it is determined that the rule target does not exist in a predetermined distance or less in the same target determination processing is not performed.

4. The target calculation method according to claim 2, wherein the merging processing includes:
outputting, as the merged target, the target state calculated based on the target state of the AI target and the target state of the rule target, for the rule target having one or more of the associated AI targets; and
outputting the rule target as the merged target for the rule target having no associated AI target.

5. The target calculation method according to claim 4, wherein the merging processing includes:
outputting, as the merged target obtained by combining a type of the AI target and a position of the rule target, the rule target having only one associated AI target,
outputting, as the plurality of merged targets obtained by combining a position of the rule target and types of the respective AI targets, the rule target having two or more associated AI targets, and
outputting, as the merged target, the rule target having no associated AI target.

6. The target calculation method according to claim 4, wherein the merging processing includes:
outputting, as the merged target having a position closer to a position of the rule target than a position of the AI target, the rule target having only one associated AI target;
outputting, as the plurality of merged targets having a position closer to a position of the rule target than a position of the AI target, the rule target having two or more associated AI targets; and
outputting, as the merged target, the rule target having no associated AI target.

7. The target calculation method according to claim 2, further comprising deterioration detection processing of detecting deterioration of the sensor output,
wherein when deterioration of the sensor output is detected by the deterioration detection processing, the merging processing merges the AI target and the rule target at a predetermined ratio to generate the merged target.

8. The target calculation method according to claim 7, wherein
the computing device further includes a storage unit that stores ratio information defining ratios of the AI target and the rule target for each type of deterioration of the sensor output, and
the merging processing identifies a type of deterioration of the sensor output and identifies a ratio of the AI target and the rule target with reference to the ratio information.

9. A computing device comprising:
an acquisition unit configured to acquire a sensor output that is an output of a sensor that acquires information on a surrounding environment;
a detection unit configured to detect a target by a plurality of techniques using the sensor output and detect a target state including at least a position and a type of the target;
a same target determination unit configured to determine a same target from a plurality of the targets detected by each of the plurality of techniques in the detection unit; and
a merging unit configured to merge the target states of the target determined to be a same target by the same target determination unit and output the merged target states as a merged target.
